(19) United States
(12) Patent Application Publication
(10) Pub. No.: US 2012/0319609 A1
(43) Pub. Date: Dec. 20, 2012

(54) LIGHT EMITTING DIODE DRIVER HAVING OFFSET VOLTAGE COMPENSATING FUNCTION

(75) Inventors: Joong Ho CHOI, Seongnam (KR); Seok Lee, Yongin (KR); Jae Hoon Kim, Seoul (KR); Jae Shin Lee, Anyang (KR); Yeun Joong Lee, Seoul (KR); Deuk Hee Park, Suwon (KR); Sang Hyun Cha, Seoul (KR); Chang Seok Lee, Seoul (KR); Jung Eui Park, Suwon (KR)

(73) Assignee: SAMSUNG ELECTRO-MECHANICS CO., LTD./University of Seoul Industry Cooperation Foundation

(21) Appl. No.: 13/288,728

(22) Filed: Nov. 3, 2011

(30) Foreign Application Priority Data
Jun. 16, 2011 (KR) 10-2011-0058285

(51) Int. Cl. H05B 37/02

(52) U.S. Cl. 315/210

(57) ABSTRACT

There is provided a light emitting diode (LED) driver having an offset voltage compensating function compensating for an offset voltage generated at the time of driving of an LED, the LED driver including: a driving unit detecting a current flowing in an LED unit having at least one LED, as a voltage and controlling the current flowing in the LED unit according to a comparison result between the detected voltage and a reference voltage having a preset voltage level; and an offset compensating unit integrating a voltage difference between the detected voltage and the reference voltage and adding or subtracting a compensating current according to an integration result to thereby compensate for an offset.

### CROSS-REFERENCE TO RELATED APPLICATIONS

This application claims the priority of Korean Patent Application No. 10-2011-0058285 filed on Jun. 16, 2011, in the Korean Intellectual Property Office, the disclosure of which is incorporated herein by reference.

### BACKGROUND OF THE INVENTION

1. Field of the Invention

The present invention relates to a light emitting diode driver for driving a light emitting diode.

2. Description of the Related Art

A cold cathode fluorescent lamp (CCFL), used as a light source for a backlight unit of a liquid crystal display (LCD), generally has disadvantages in that it uses mercury gas to thereby cause environmental pollution, has a slow response speed and low color reproducibility, and is not suitable for implementing slimness and lightness in an LCD panel.

Therefore, a light emitting diode (hereinafter, referred to as an LED) has recently been actively used in a display device. The LED has advantages in that it is environmentally-friendly, has a response speed of several nano seconds to thus enable a high speed response, such that it is effective for use with a video signal stream, may perform impulse driving, has high color reproducibility, may arbitrarily change brightness, color temperature, or the like, by controlling the amount of light emitted from red, green, and blue LEDs, and is suitable for implementing slimness and lightness in an LCD panel, as compared to a CCFL.

In the backlight unit using the LED, an LED driver supplying a current to the LED to thereby drive the LED is necessarily used.

In the LED driver, an amplifier capable of detecting a current flowing in the LED as a voltage, comparing the detected voltage with a reference voltage, and controlling the current flowing in the LED according to the comparison result is used. In this amplifier, an offset voltage may be generated according to a manufacturing method, a manufacturing process, or the like, used therefor.

In this manner, when an offset voltage is generated in the amplifier, both input terminals of the amplifier may not be accurately virtually short-circuited, such that an output of the amplifier may not show an accurate value according to an input thereof. Therefore, the brightness of the LED may not be accurately controlled.

### SUMMARY OF THE INVENTION

An aspect of the present invention provides a light emitting diode (LED) driver having an offset voltage compensating function compensating for an offset voltage generated at the time of a driving of an LED.

According to an aspect of the present invention, there is provided a light emitting diode (LED) driver having an offset voltage compensating function, the LED driver including: a driving unit detecting a current flowing in an LED unit having at least one LED, as a voltage and controlling the current flowing in the LED unit according to a comparison result between the detected voltage and a reference voltage having a preset voltage level; and an offset compensating unit integrating a voltage difference between the detected voltage and the reference voltage and adding or subtracting a compensating current according to an integration result to thereby compensate for an offset.

The offset compensating unit may add or subtract the compensating current to or from a point at which the current flowing in the LED unit is detected, according to the integration result.

The offset compensating unit may include: an integrator integrating the voltage difference between the detected voltage and the reference voltage; and an amplifier amplifying the integration result of the integrator to thereby provide the compensating current. The integrator may include: a first switch switching a transfer path of the reference voltage; a second switch switching a transfer path of the detected voltage; a third switch connected between an integration result input terminal of the amplifier and a ground; a fourth switch switching the transfer paths of the reference voltage and the detected voltage of the first and second switches; a fifth switch switching a transfer path between the integration result input terminal of the amplifier and the fourth switch; a first capacitor having one end and the other end connected between the first and second switches and the fourth switch;

a second capacitor connected between the other end of the first capacitor and the third switch; and a comparator transferring an integration result of levels of the reference voltage and the detected voltage from the first and second switches to the fifth switch.

The third switch may switch on for a preset time and then be maintained in a switch-off state at the time of an integration operation, the first and fourth switches repeat switch-on and switch-off operations for a preset time at a preset period, and the second and fifth switches may repeat switch-on and switch-off operations for a preset time at a preset period, while switching on during a switch-off interval of the first and fourth switches and switching off during a switch-on interval thereof.

The third switch may switch on at the same time as that of the first and fourth switches.

The amplifier may be a transconductance amplifier. The driving unit may include: a comparing unit providing a switching signal according to the comparison result between the detected voltage and the reference voltage; a transistor turned on or turned off according to the switching signal to thereby control a level of the current flowing in the LED unit; a first resistor detecting the current flowing in the LED unit; and a second resistor transferring the detected voltage and the compensating current.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing a configuration of a light emitting diode (LED) driver according to an embodiment of the present invention;

FIG. 2 is a view schematically showing a configuration of an offset compensating unit used in an LED driver according to an embodiment of the present invention;

FIG. 3 is a timing graph of each switch of an integrator employed in an offset compensating unit used in an LED driver according to an embodiment of the present invention; and

FIG. 4 is a graph showing that an offset voltage is compensated for by an LED driver according to an embodiment of the present invention.

### DETAILED DESCRIPTION OF THE PREFERRED EMBODIMENT

Embodiments of the present invention will now be described in detail with reference to the accompanying drawings.

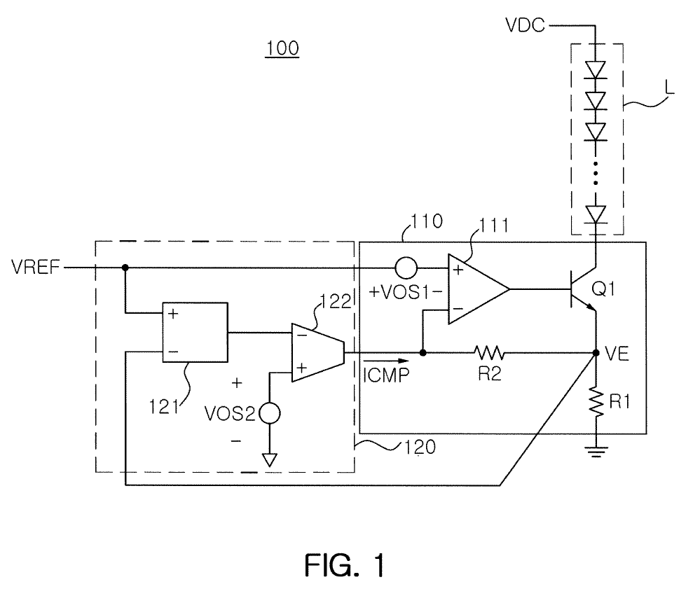

FIG. 1 is a view schematically showing a configuration of a light emitting diode (LED) driver according to an embodiment of the present invention.

Referring to FIG. 1, an LED driver 100 according to the embodiment of the present invention may include a driving unit 110 and an offset compensating unit 120.

The driving unit 110 may drive an LED unit L by controlling a current flowing in the LED unit L, including at least one LED.

More specifically, the LED unit L may include a single LED receiving a preset driving power VDC, an LED string in which a plurality of LEDs are connected in series with each other, an LED group in which the plurality of LEDs are connected in parallel with each other, or an LED ground in which a plurality of LED strings are connected in parallel with each other.

That is, the driving unit 110 may detect the current flowing in the LED unit L as a voltage, compare a level of the detected voltage with a preset level of a reference voltage, and control the current flowing in the LED unit according to the comparison result to thereby control brightness of the LED unit.

To this end, the driving unit 110 may include a comparing unit 111, a transistor Q1, and first and second resistors R1 and R2.

The comparing unit 111 may compare the level of a detected voltage VE with the preset level of a reference voltage VREF, and the transistor Q1 may be connected between the other end of the LED unit L opposing to one end of the LED unit L to which the driving power VDC is input, and a ground, and be turned on or turned off according to the comparison result from the comparing unit 111 to thereby control the current flowing in the LED unit L. The first resistor R1 may be connected between the transistor Q1 and the ground and be controlled by the transistor Q1 to thereby detect the current flowing in the LED unit L as a voltage value. The second resistor R2 may transfer the voltage VE detected by the first resistor R1 to the comparing unit 111. Meanwhile, in the comparing unit 111, an offset voltage VOS1 may be generated according to a manufacturing method, a manufacturing process, or the like. Therefore, it is required to compensate for the offset voltage.

The offset compensating unit 120 may integrate a voltage difference between the detected voltage and the reference voltage and add or subtract a compensating current according to the integration result to thereby compensate for the offset voltage.

More specifically, the offset compensating unit 120 may add or subtract the compensating current to or from a point at which the current flowing in the LED unit is detected according to the integration result.

To this end, the offset compensating unit 120 may include an integrator 121 integrating the voltage difference between the detected voltage VE and the reference voltage VREF and an amplifier 122 amplifying the integration result of the integrator 121 to thereby provide the compensating current.

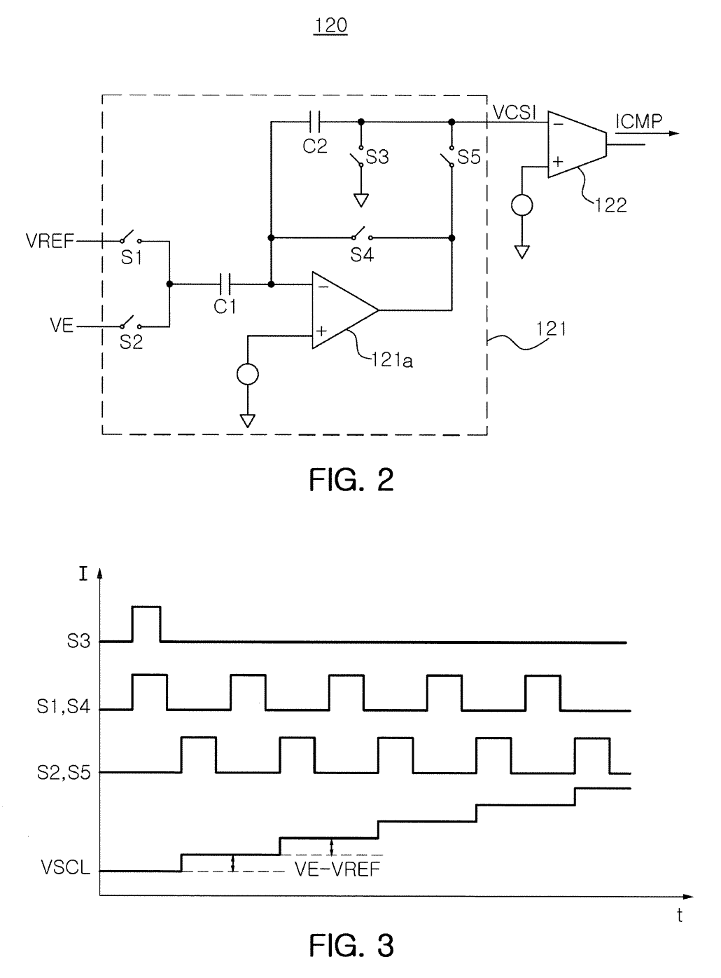

FIG. 2 is a view schematically showing a configuration of an offset compensating unit used in an LED driver according to an embodiment of the present invention.

Referring to FIGS. 1 and 2, the integrator 121 may include a first switch S1 switching a transfer path of the reference voltage VREF, a second switch S2 switching a transfer path of the detected voltage VE, a third switch S3 connected between an integration result input terminal of the amplifier 122 and a ground, a fourth switch S4 switching the transfer paths of the reference voltage VREF and the detected voltage VE of the first and second switches S1 and S2, a fifth switch S5 switching a transfer path between the integration result input terminal of the amplifier 122 and the fourth switch S4, a first capacitor C1 having one end and the other end thereof connected between the first and second switches S1 and S2 and the fourth switch S4, a second capacitor C2 connected between the other end of the first capacitor C1 and the third switch, and a comparator 121a transferring an integration result of levels of the reference voltage VREF and the detected voltage VE from the first and second switches S1 and S2 to the fifth switch S5. In this configuration, an offset voltage may be generated in the comparator 121a according to a manufacturing method, a manufacturing process, or the like. However, since the comparator 121a is connected to a ground, such that the offset voltage does not have an influence on the reference voltage VREF and the detected voltage VE, the influence of the offset voltage VOS2 may be neglected.

FIG. 3 is a timing graph of each switch of an integrator employed in an offset compensating unit used in an LED driver according to an embodiment of the present invention.

Referring to FIGS. 2 and 3, the third switch S3 may switch on for a preset time and then be maintained in a switch-off state at the time of integration operation, the first and fourth switches S1 and S4 may repeat switch-on and switch-off operations for a preset time at a preset period, and the second and fifth switches S2 and S5 may repeat switch-on and switch-off operations for a preset time at a preset period. Here, the second and fifth switches S2 and S5 may switch on during a switch-off interval of the first and fourth switches S1 and S4 and may switch off during a switch-on interval thereof. In addition, the third switch S3 may switch on at the same time as that of the first and fourth switches S1 and S4.

The amplifier 122 may be a transconductance amplifier capable of amplifying a current according to the integration result.

The amplifier 122 may be formed in a negative feedback loop of the comparing unit 111 and apply a compensating current ICMP to a voltage detection point through the second resistor R2, in order to remove the offset voltage VOS1 generated by the comparing unit 111.

Due to the compensating current ICMP, a voltage drop reaching up to a voltage level of the detected voltage VE detected at a negative input terminal of the comparing unit 111 may be generated. Here, a voltage difference between both ends of the second resistor R2 is allowed to be the same as the offset voltage VOS1, such that the detected voltage VE to be finally detected, and the reference voltage VREF have the same voltage level.

A transfer function of the detected voltage VE with respect to the reference voltage VREF may be represented by the following Equation 1.

$$VE ≅ VREF + \frac{1}{GM \cdot R 2} \frac{S τ}{1 + \frac{S τ}{GM \cdot R 2}} ( VOS 1 + GM \cdot R 2 \cdot VOS 2 ) \qquad [ Equation 1 ]$$

Where GM indicates a transconductance value of the transconductance amplifier 122, and VOS1 and VOS2 indicate, respectively, offset voltages of the comparing unit 111 and the amplifier 122 of FIG. 1. In addition, S indicates a transfer function, and τ indicates a time constant.

Since the offset voltage means a point at which a frequency is zero, when a final value theorem is performed with respect to the transfer function of Equation 1, the following Equation 2 is given, and the offset voltage is removed in a steady state. It may be confirmed through this Equation that an offset voltage of the amplifier 122 has also been removed.

$${VE}_{Stdady - State} = {lim}_{s \to 0} [ s \cdot VE ( s ) ] = VREF \qquad [ Equation 2 ]$$

As described above, the detected voltage VE has the same voltage value as that of the reference voltage VREF.

Meanwhile, in the comparator 121a, an offset voltage may also be generated according to a manufacturing method, a manufacturing process, or the like. An integration result of the integrator 121 by a clock signal having timing as shown in FIG. 3 may be represented by the following Equation 3.

VSCI(n)=C1/C2(VE(n))−VREF) [Equation 3]

Where VSCI indicates an output voltage of the integrator 121. When viewed from the transfer function, it may be confirmed that the offset voltage of the comparator 121a does not have an influence on an output.

That is, the offset voltage VOS2 of the amplifier 122 may be removed by the first to fifth switches S1 to S5 and the first and second capacitors C1 and C2 of the integrator 121.

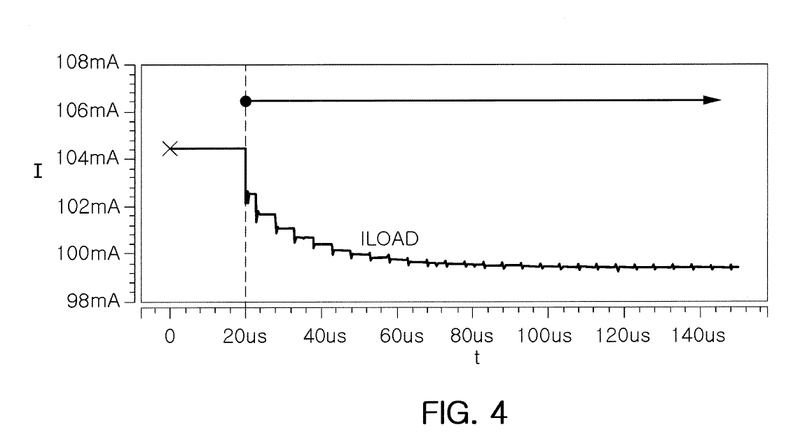

FIG. 4 is a graph showing that an offset voltage is compensated for by an LED driver according to an embodiment of the present invention.

Referring to FIGS. 1, 2, and 4, in the LED driver 100 according to the embodiment of the present invention, when an offset of approximately 5 mA of a current flowing in the LED unit L is generated by the comparing unit 111 of the driving unit 110, the offset is gradually compensated for by the compensating current provided by the amplifier 122 according to the integration result of the integrator 121, such that an accurate value of current ILOAD is supplied to the LED unit L.

As described above, according to the embodiment of the present invention, the offset voltage is compensated for by an additional transconductance amplifier and an integration circuit, whereby the brightness of the LED may be accurately controlled. In addition, the offset voltage may be compensated for by using an additional circuit only, without changing the existing LED driving circuit, whereby the reliability the driving of the LED may be maintained.

As set forth above, according to the embodiment of the present invention, the offset voltage generated at the time of the driving of the LED could be compensated for, whereby the brightness of the LED could be accurately controlled.

While the present invention has been shown and described in connection with the exemplary embodiments, it will be apparent to those skilled in the art that modifications and variations can be made without departing from the spirit and scope of the invention as defined by the appended claims.

What is claimed is:

1. A light emitting diode (LED) driver having an offset voltage compensating function, the LED driver comprising:
a driving unit detecting a current flowing in an LED unit having at least one LED, as a voltage and controlling the current flowing in the LED unit according to a comparison result between the detected voltage and a reference voltage having a preset voltage level; and
an offset compensating unit integrating a voltage difference between the detected voltage and the reference voltage and adding or subtracting a compensating current according to an integration result to thereby compensate for an offset.

2. The LED driver of claim 1, wherein the offset compensating unit adds or subtracts the compensating current to or from a point at which the current flowing in the LED unit is detected, according to the integration result.

3. The LED driver of claim 1, wherein the offset compensating unit includes:
an integrator integrating the voltage difference between the detected voltage and the reference voltage; and
an amplifier amplifying the integration result of the integrator to thereby provide the compensating current.

4. The LED driver of claim 2, wherein the integrator includes:
a first switch switching a transfer path of the reference voltage;
a second switch switching a transfer path of the detected voltage;
a third switch connected between an integration result input terminal of the amplifier and a ground;
a fourth switch switching the transfer paths of the reference voltage and the detected voltage of the first and second switches;
a fifth switch switching a transfer path between the integration result input terminal of the amplifier and the fourth switch;
a first capacitor having one end and the other end connected between the first and second switches and the fourth switch;
a second capacitor connected between the other end of the first capacitor and the third switch; and
a comparator transferring an integration result of levels of the reference voltage and the detected voltage from the first and second switches to the fifth switch.

5. The LED driver of claim 4, wherein the third switch switches on for a preset time and then is maintained in a switch-off state at the time of integration operation,
the first and fourth switches repeat switch-on and switch-off operations for a preset time at a preset period, and
the second and fifth switches repeat switch-on and switch-off operations for a preset time at a preset period, while switching on during a switch-off interval of the first and fourth switches and switching off during a switch-on interval thereof.

6. The LED driver of claim 5, wherein the third switch switches on at the same time as that of the first and fourth switches.

7. The LED driver of claim 3, wherein the amplifier is a transconductance amplifier.

8. The LED driver of claim 1, wherein the driving unit includes:
a comparing unit providing a switching signal according to the comparison result between the detected voltage and the reference voltage;
a transistor turned on or turned off according to the switching signal to thereby control a level of the current flowing in the LED unit;
a first resistor detecting the current flowing in the LED unit; and
a second resistor transferring the detected voltage and the compensating current.
